(19) United States
(12) Patent Application Publication
(10) Pub. No.: US 2005/0055217 A1
(43) Pub. Date: Mar. 10, 2005

(54) System that translates by improving a plurality of candidate translations and selecting best translation

(75) Inventors: Eiichiro Sumita, Soraku-gun (JP); Taro Watanabe, Soraku-gun (JP)

Correspondence Address: McDermott, Will & Emery, 600 13th Street, N.W., Washington, DC, 20005-3096, US

(73) Assignee: ADVANCED TELECOMMUNICATIONS RESEARCH INSTITUTE INTERNATIONAL

(21) Appl. No.: 10/917,506

(22) Filed: Aug. 13, 2004

(30) Foreign Application Priority Data
Sep. 9, 2003 (JP) 2003-316236
May 21, 2004 (JP) 2004-151966

(51) Int. Cl. G10L 11/00

(52) U.S. Cl. 704/277

(57) ABSTRACT

A machine translation system includes: a distributing module for distributing an input sentence to a plurality of machine translation apparatuses for generating a translation of a second language of the input sentence of a first language, and receiving the translation of the second language from each of the plurality of translation apparatuses; a translation improving module, using each of the translations of the second language received by the distributing module as a starting point, improving the translation such that an evaluation in accordance with a prescribed evaluation method is improved; and a translation selecting module for selecting, as a translation of the input sentence, a translation satisfying a prescribed condition, among the translations improved by the translation improving module.

### BACKGROUND OF THE INVENTION

1. Field of the Invention

The present invention relates to a machine translation system and, more specifically, to a machine translation system capable of performing highly precise translation making use of available language resources in translation between arbitrary two languages.

2. Description of the Background Art

Because of rapid globalization of social and economical activities, efficient construction of a machine translation system designed for new languages or new fields has been desired. Further, in the field of translation of written languages that has been already commercialized and used widely as well as in the field of translation of spoken languages that is ardently being studied and to be practically applied in the near future, translation quality higher than the current level is desired.

Conventionally, implementation of a machine translation system has required experts proficient in two languages involved in the translation, years of working, and formidable cost. Such a machine translation system cannot realize highly flexible portability or high quality. For the future, a machine translation system must be constructed through mechanized and industrialized manner with less human resources.

Currently, in the worldwide researches of machine translation, a method utilizing a corpus has been attaining a breakthrough success over the conventional methods. Two representative approaches utilizing the corpus include (1) example-based translation and (2) statistical translation. These two methods are both capable of constructing a system for machine translation through semi-automatic learning process using a corpus.

In example-based translation, given an input sentence of a first language, a sentence of the first language similar to the input sentence is searched out from a bilingual corpus, and based on a translation (second language) of the thus searched out sentence of the first language, an output sentence is generated.

In statistical translation statistical models of translations and language are learned from a bilingual corpus, and at the time of execution, a translation that would attain maximum probability is searched in accordance with these two statistical models.

In the following, among the representative translation methods of the prior art, the statistical translation will be described, followed by a conventional approach to improve the accuracy of the statistical translation.

The framework of statistical machine translation formulates the problem of translating a sentence in a language (represented by J) into another language (represented by E) as the maximization problem of the following conditional probability P(E|J).

Ê=arg_{E}maxP(E|J)

According to the Bayes' Rule, Ê may be rewritten as:

Ê=arg_{E}max P(E)P(J|E)/P(J)

where Ê is independent of the term P(J). Therefore,

Ê=arg_{E}maxP(E)P(J|E).

The first term P(E) on the right side is called a language model, representing the likelihood of sentence E. The second term P(J|E) is called a translation model, representing the generation probability from sentence E to sentence J.

As an approach overcoming the limitation of such a method, a method has been proposed, in which each word of a channel target sentence is translated into a channel source language, the resulting translated words are positioned in the order of the channel target sentence, and various operators are applied to the resulting sentence to generate a number of sentences. (Ulrich Germann, Michael Jahr, Kevin Knight, Daniel Marcu, and Kenji Yamada, “Fast decoding and optimal decoding for machine translation,” (2001) in Proc. of ACL2001, Toulouse, France.) In this proposed method, the sentence having the highest likelihood among the thus generated sentences is selected as the translation.

### DISCLOSURE OF THE INVENTION

No matter which of the conventional methods of example-based translation and statistical translation is used, the resulting system is within a framework of generating a relevant translation in accordance with a certain principle and language data. Therefore, if higher translation quality is desired, the inner machine translation system itself must be changed. Therefore, improvement has been difficult considering necessary time, labor and cost.

The method proposed by Germann et al. is problematic because the search often reaches a local optimal solution, and it is not the case that highly accurate solution is stably obtained.

In addition, even if a new translation method or methods would emerge in the future, each of such methods would be self-complete, and there is no framework that enables generation of high quality translations overcoming the limitations of such new methods.

### SUMMARY OF THE INVENTION

Therefore, an object of the present invention is to provide a machine translation system capable of providing high quality translation regardless of language combinations.

Another object of the present invention is to provide a machine translation system capable of providing, in a reasonable time, high quality translation regardless of language combinations.

A further object of the present invention is to provide a machine translation system, capable of stably providing high quality translation regardless of language combinations, making use of available translation resources effectively.

According to a first aspect, the present invention provides a machine translation system including: a distributing module for distributing an input sentence to each of a plurality of machine translation apparatuses for generating a translation of a second language of the input sentence of a first language, and receiving the translation of the second language from each of the apparatuses; a translation improving module, using each of the translations of the second language received by the distributing module as a starting point, improving the translation such that an evaluation in accordance with a prescribed evaluation method is improved; and a translation selecting module for selecting, as a translation of the input sentence, a translation satisfying a prescribed condition, among the translations improved by the translation improving module.

Translations provided by a plurality of machine translation apparatuses are prepared by the distributing module. The translations are improved by the translation improving module, so that the translations come to have higher evaluations. Among the improved translations, one satisfying a prescribed condition is selected by the translation selecting module, as a translation of the input sentence. A plurality of translations prepared at first are improved to have higher evaluations, and therefore, eventually, a translation that has higher evaluation than any of the initially prepared translations can be obtained. As a translation satisfying a prescribed condition is selected as the translation of the input sentence, a translation of the input sentence that has high quality and satisfies a prescribed condition can be obtained.

Preferably, the machine translation system may include a plurality of machine translation apparatuses each connected to the distributing module, and the plurality of machine translation apparatuses may include first and second machine translation apparatuses of mutually different types. As the translations are prepared at first using a plurality of machine translation apparatuses, particularly the machine translation apparatuses of mutually different types, it is likely that the prepared translations as seeds for improvement are not similar to each other. Therefore, it is also likely that optimal solutions derived therefrom are not similar to each other, and that one of the solutions is a global optimal solution.

The translation improving module may include a translation modifying module for applying a prescribed modification on an input translation, a translation evaluating module for evaluating the translation modified by the translation modifying module, and a repetition control module for determining whether the evaluation by the translation evaluating module has been improved from the evaluation of the input translation, and for controlling the translation modifying module and the evaluating module such that modification and evaluation are repeated until the evaluation is no longer improved.

Modification and evaluation of a translation are repeated until the evaluation is no longer improved. Therefore, using each translation as a starting point, a plurality of local optimal solutions can be obtained. As there are a plurality of initial translations, it is highly likely that a global optimal solution exists among the local solutions.

Preferably, the translation modifying module includes a module for applying a plurality of different modifications on one translation to generate a plurality of modified translations, and the evaluating module includes a module for evaluating each of the plurality of modified translations.

From one translation, a plurality of translations are generated by a plurality of different modifications. Possibility of finding a translation of high evaluation increases if the translations to be evaluated have wider variations, and hence, larger number of translations should preferably be subjected to evaluation. Therefore, the present arrangement improves the possibility of eventually attaining a translation of high evaluation.

Preferably, the translation selecting module includes a module for selecting, from among the plurality of translations obtained by the repetition by the repetition control module, one that has the highest evaluation by the evaluating module.

A plurality of translations are obtained in the last stage, and it is highly possible that one having the highest evaluation among these is the global optimal solution. When such a translation is selected, it becomes highly possible that the translation of highest quality is obtained.

More preferably, the translation evaluating module includes a module for computing likelihood of a translation based on language model of the second language and a translation model from the second language to the first language.

As the likelihood is used as an evaluation, it becomes highly likely that the resulting translation is a natural sentence of the second language that well corresponds to the input sentence.

According to a second aspect, the present invention provides a recording medium that contains a machine translation program that, when executed on a computer, causes the computer to operate as a machine translation system described above.

According to a third aspect, the present invention provides a control apparatus for a machine translation system, including: a translation obtaining module for providing an input sentence of a first language to a plurality of machine translation apparatuses of mutually different types and obtaining corresponding translations of a second language; a modified translation obtaining module for applying the translations of the second language obtained by the translation obtaining module to a plurality of translation modifying module for modifying the translation to have an evaluation in accordance with a prescribed evaluation method, using each of the translations of the second language as a starting point, and receiving modified translations and respective accompanying evaluation values; and a translation selecting module for selecting and outputting as a translation of the input sentence, one of the translations received by the modified translation obtaining module, which satisfies a prescribed condition.

According to a fourth aspect, the present invention provides a method of machine translation including the steps of: preparing a plurality of candidate translations by distributing an input sentence to each of a plurality of machine translation apparatuses for generating a translation of a second language for the input sentence of a first language, and receiving translations of the second language for the input sentence; modifying each of the plurality of candidate translations received in the step of preparation and improving each candidate translation so that an evaluation computed in accordance with a prescribed evaluation method is improved; and selecting, from among the improved candidate translations improved in the step of improving, one that satisfies a prescribed selection condition, as a translation of the input sentence.

Preferably, the step of improving includes the steps of: modifying each of the plurality of candidate translations in accordance with a prescribed modification method; evaluating the candidate translations modified in the step of modifying, in accordance with an evaluation method; determining whether the evaluation value of the candidate translation given in the step of evaluation has been improved from the evaluation of the candidate translation input in the step of modifying; and repeating, on each of the modified translations modified in the step of modifying, the steps of modification and evaluation, until the evaluation value no longer improves in the step of determination.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a functional block diagram of a machine translation system in accordance with a first embodiment of the present invention.

FIG. 2 is a more detailed functional block diagram of a candidate translation generating unit 32 shown in FIG. 1.

FIG. 3 is a detailed functional block diagram of a first translation apparatus 35A shown in FIG. 2.

FIG. 4 is a detailed functional block diagram of a second translation apparatus 35B shown in FIG. 2.

FIG. 5 is a detailed functional block diagram of a third translation apparatus 35C shown in FIG. 2.

FIG. 6 is a detailed functional block diagram of a fourth translation apparatus 35D shown in FIG. 2.

FIG. 7 is a schematic illustration showing a translation merging process.

FIG. 8 is a detailed functional block diagram of a fifth translation apparatus 35E shown in FIG. 2.

FIG. 9 is an illustration showing a translation structure sharing process.

FIG. 10 is a functional block diagram of a translation improving unit 36 shown in FIG. 1.

FIG. 11 is a functional block diagram of a machine translation system in accordance with a second embodiment of the present invention.

FIG. 12 is a functional block diagram of a first best translation generating unit 102A shown in FIG. 11.

FIG. 13 shows a network configuration of the machine translation system in accordance with the second embodiment.

FIG. 14 shows an appearance of a computer implementing the machine translation system in accordance with one embodiment of the present invention.

FIG. 15 is a block diagram of the computer shown in FIG. 14.

### DESCRIPTION OF THE PREFERRED EMBODIMENTS

### First Embodiment

The machine translation system in accordance with the present embodiment is based on a new framework combining an existing translation resource with a translation improving method.

### Configuration

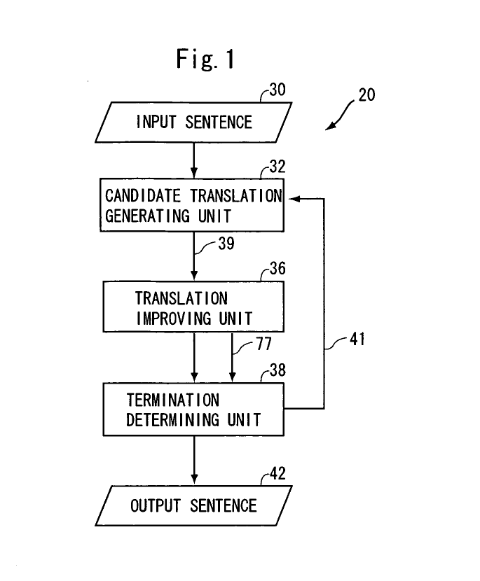

FIG. 1 is a block diagram showing a machine translation system 20 in accordance with the present embodiment. Referring to FIG. 1, machine translation system 20 translates an input sentence 30 of a first language (language J) to an output sentence 42 as a translation of a second language (language E). Machine translation system 20 includes: a candidate translation generating unit 32 for receiving input sentence 30 of the first language, generating translations in accordance with various machine translation methods as will be described later as candidate translations and outputting the same in a prescribed order; a translation improving unit 36 improving the candidate translations output from candidate translation generating unit 32 in accordance with a method described later, and outputting a best candidate translation when a prescribed condition is satisfied; and a termination determining unit 38 responsive to an output of improved candidate translations from translation improving unit 36 for determining whether a prescribed termination condition has been satisfied or not, and when the termination condition has been satisfied, selecting and outputting a translation having highest score evaluated in accordance with a prescribed evaluation criterion, from among the improved candidate translations obtained by that time.

Termination determining unit 38 has a function of transmitting, when it is determined that the termination condition has not been satisfied yet, a control signal 41 to instruct generation of initial candidates again, to candidate translation generating unit 32. Candidate translation generating unit 32 has a function of generating, in response to control signal 41, initial candidates that are different from those generated last time and applying the generated initial candidates to translation improving unit 36.

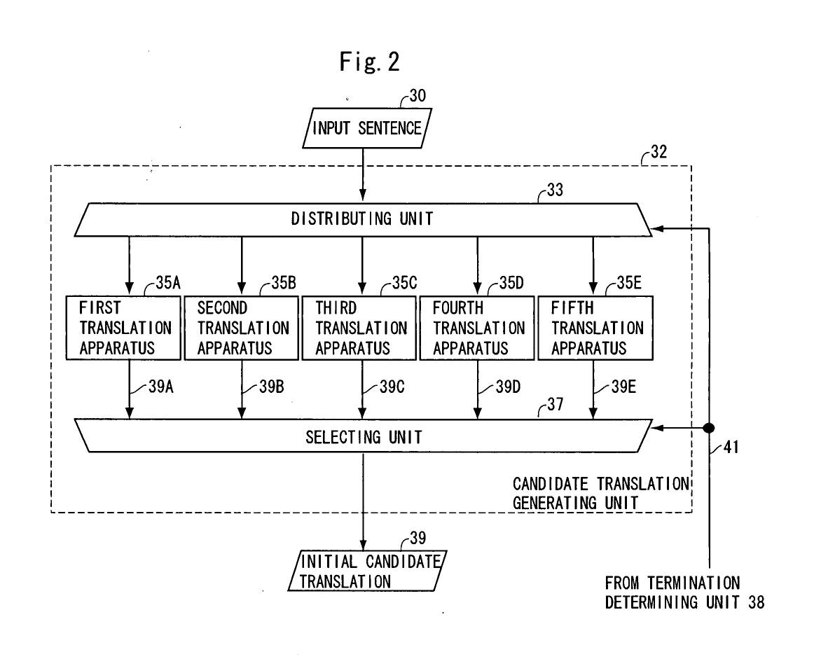

FIG. 2 is a more detailed functional block diagram of candidate translation generating unit 32. Referring to FIG. 2, candidate translation generating unit 32 includes: first to fifth translation apparatuses 35A to 35E translating a given sentence and outputting respective translations 39A to 39E; a distributing unit 33 distributing input sentence 30 to any of the first to fifth translation apparatuses 35A to 35E in accordance with control signal 41 from termination determining unit 38; and a selecting unit 37 selecting, in accordance with control signal 41 from termination determining unit 38, a translation output from the translation apparatuses that have received input sentence 30 and outputting the same as initial candidate translation 39.

In the present embodiment, translation apparatuses 35A to 35E translate in accordance with mutually different methods. Therefore, given one input sentence 30, it is highly possible that the first to fifth translation apparatuses 35A to 35E provide mutually different translations 39A to 39E. Though five translation apparatuses are used in this example, the number is not limited to 5, and what is necessary is to employ at least two translation machines. Further, it may be possible to use translation apparatuses of the same type using different translation knowledge.

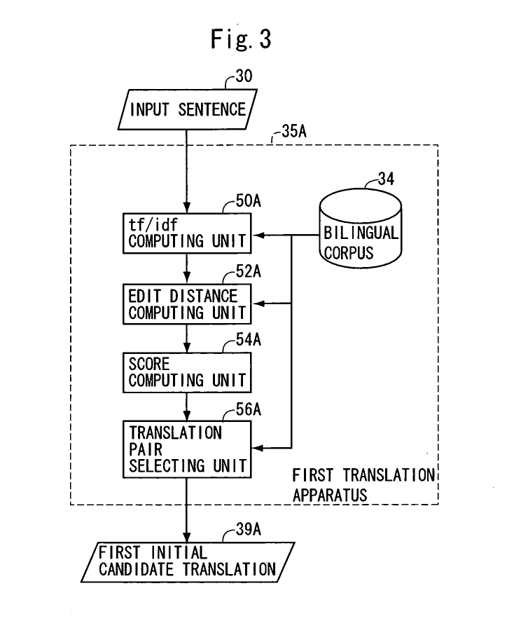

FIG. 3 is a detailed block diagram of the first translation apparatus in accordance with the present embodiment. Referring to FIG. 3, the first translation apparatus 35A includes a bilingual corpus 34 containing a number of translation pairs each consisting of a sentence of a first language and a translation of a second language, and a tf/idf computing unit 50A for computing a tf/idf criteria P_{tf/idf} as a measure representing similarity between input sentence 30 and each of the sentences of the first language in bilingual corpus 34, with reference to bilingual corpus 34. The tf/idf criteria P_{tf/idf} is defined by the following equation using a concept of document frequency, which is generally used in information retrieval algorithm, by treating each sentence of the first language in bilingual corpus 34 as one document.

$${P}_{tf / idf} ( {J}_{k} , {J}_{0} ) = {\sum }_{i : {J}_{0 , i} ∈ {J}_{k}}^{} \frac{log ( N / df ( {J}_{0 , i} ) ) / log N}{\vert {J}_{0} \vert}$$

where J₀ is the input sentence, J_{0,i} is the i-th word of input sentence J₀, df(J_{0,i}) is the document frequency for the i-th word J_{0,i} of the input sentence J₀, and N is the total number of translation pairs in bilingual corpus 34. The document frequency df(J_{0,i}) refers to the number of documents (in the present embodiment, sentences) in which the i-th word J_{0,i} of input sentence J₀ appears.

The first translation apparatus 35A further includes an edit distance computing unit 52A for computing an edit distance dis(Jₖ, J₀) by performing DP (Dynamic Programming) matching between a sentence Jk of the first language in each translation pair (Jk, Ek) contained in bilingual corpus 34 and the input sentence J₀, and a score computing unit 54A for computing the score of each sentence in accordance with the equation below, based on the tf/idf criteria P_{tf/idf} computed by tf/idf computing unit 50A and on the edit distance computed by edit distance computing unit 52A.

The edit distance dis(Jₖ, J₀) computed by edit distance computing unit 52A is represented by the following equation.
dis(Jₖ,J₀)=I(Jₖ,J₀)+D(Jₖ,J₀)+S(Jₖ,J₀)

where k is an integer satisfying 1≦k≦N, and I(Jₖ, J₀), D(Jₖ, J₀) and S(Jₖ, J₀) are the number of insertions/deletions/substitutions respectively, from sentence J₀ to sentence Jₖ. The edit distance may be computed using a readily available software tool.

The score computed by score computing unit 54A is represented by the following equation.

$$score = \{ \begin{matrix}( 1.0 - α ) ( 1.0 - \frac{dis ( {J}_{k} , {J}_{0} )}{\vert {J}_{0} \vert} ) + α {P}_{tf / idf} ( {J}_{k} , {J}_{0} ) & ( if dis ( {J}_{k} , {J}_{0} ) > 0 ) \\ 1.0 & ( otherwise )\end{matrix}$$

where α is a tuning parameter, and is set to α=0.2 in the present embodiment.

Referring to FIG. 3, the first translation apparatus 35A further includes a translation pair selecting unit 56A for selecting, based on the score computed by score computing unit 54A, a translation pair having the highest score, outputting the sentence of the second language included in the translation pair as a first initial candidate translation 39A and applying the same to translation improving unit 36 shown in FIG. 1.

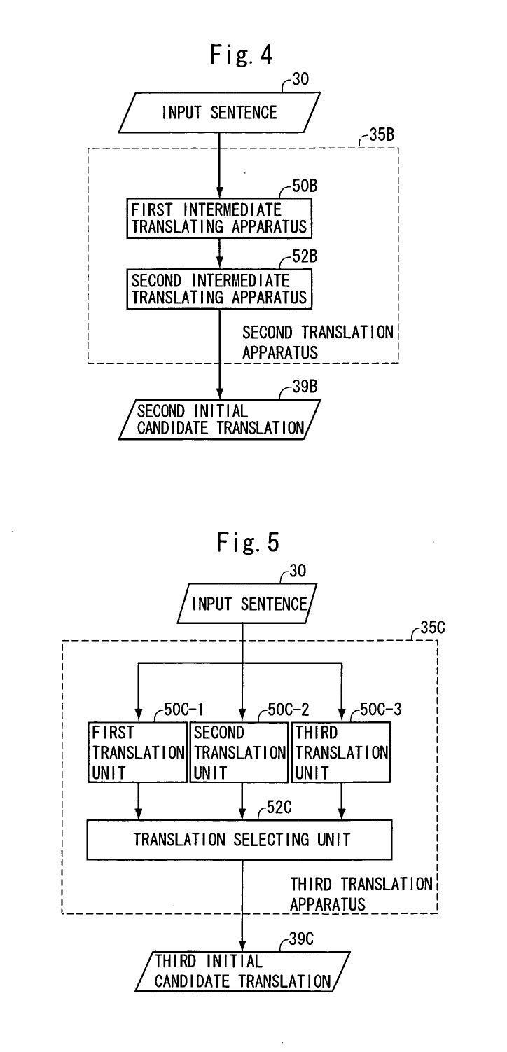

FIG. 4 shows, in a block diagram, a configuration of the second translation apparatus 35B. Referring to FIG. 4, the second translation apparatus 35B includes a first intermediate translating apparatus 50B implemented with an existing translation system, for translating input sentence 30 of the first language to a sentence of a third language, and a second intermediate translation apparatus 52B for translating the sentence of the third language as an output from the first intermediate translation apparatus 50B to a sentence of the second language.

Where high performance translation apparatuses are available as the first and second intermediate translation apparatuses 52A and 52B, good translation results may be obtained by translating from the first language to the second language through a third language. In the system of the present embodiment, the result of translation obtained by using an intermediate language may be used as the initial candidate translation.

Here, the first and third languages may be different languages, or may be the same, one language. In that case, the first intermediate translation apparatus 50B is an apparatus for paraphrasing in the first language. Further, the second and third languages may be different languages, or may be the same, one language. In that case, the second intermediate translation apparatus 52B is an apparatus for paraphrasing in the second language.

FIG. 5 is a detailed block diagram of the third translating apparatus 35C. Referring to FIG. 5, the third translation apparatus 35C includes first to third translation units 50C-1 to 50C-3 based on mutually different translation methods for translating input sentence 30 to the second language, and a translation selecting unit 52C evaluating quality of outputs from the first to third translation units 50C-1 to 50C-3 in accordance with a prescribed criterion, selecting one considered the best in accordance with the criterion and outputting the same as the third initial candidate translation 39C.

The translation methods of the first to third translation units 50C-1 to 50C-3 may be any methods provided that they are different from each other.

There may be various criteria to be used for evaluation of translation at translation selecting unit 52C. These criteria, however, may be common to the criteria for evaluating translation at translation improving unit 36, and therefore, detailed description will not be given here.

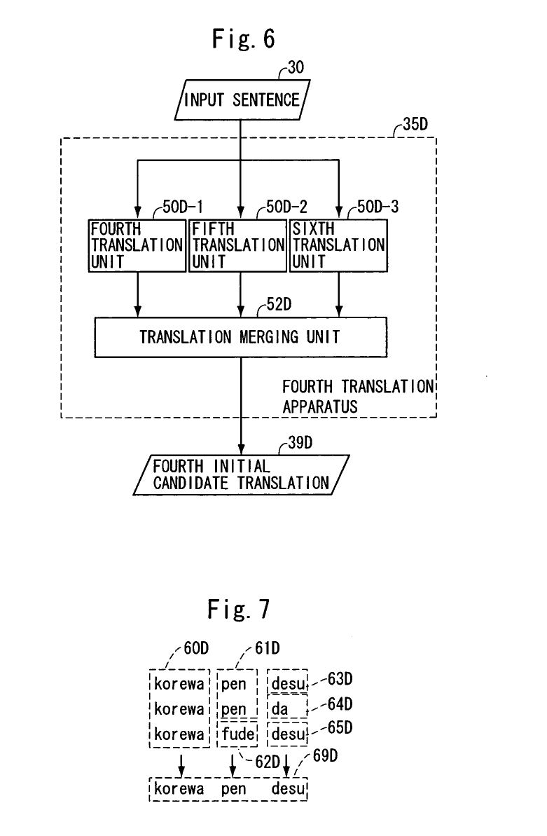

FIG. 6 is a detailed block diagram of the fourth translation apparatus 35D. Referring to FIG. 6, the fourth translation apparatus 35D includes fourth to sixth translation units 50D-1 to 50D-3 based on mutually different translation methods for translating input sentence 30 to the second language, and a translation merging unit 52D for merging outputs from the fourth to sixth translation units 50D-1 to 50D-3 and outputting the result as a fourth initial candidate translation 39D.

Similar to the first to third translation units 50C-1 to 50C-3, the translation methods of the fourth to sixth translation units 50D-1 to 50D-3 may be any methods provided that they are different from each other.

The merge of translations by translation merging unit 52D refers to the following process. For simplicity of description, assume that the input sentence is an English sentence “This is a pen.” Referring to FIG. 7, the fourth to sixth translation units 50D-1 to 50D-3 respectively provide translations “korewa pen desu,” “korewa pen da,” and “korewa fude desu.” In the translation merging, each word or words constituting the sentences are compared translation by translation, and the word or words found most frequently among the translations are selected as the word or words of the merged translation.

In the example shown in FIG. 7, the portion surrounded by frame 60D is common to the three translations, and therefore, “korewa” is selected as an element of the translation. Next, as represented by frames 61D and 62D, the word “pen” are found in two translations, while “fude” is found in only one translation. Therefore, “pen” is selected as an element of the translation from this portion. Similarly, from frames 63D to 65D, “desu” is selected. As a result, “korewa pen desu” surrounded by frame 69D is obtained as a merged translation.

Generally speaking, when a word or words are commonly used among a plurality of machine translation systems, it is highly possible that the word or words are relevant translation or translations. Therefore, the merging process described above increases the possibility of finding a translation closer to the correct translation. Thus, a result of the merging process is utilized as the initial candidate translation.

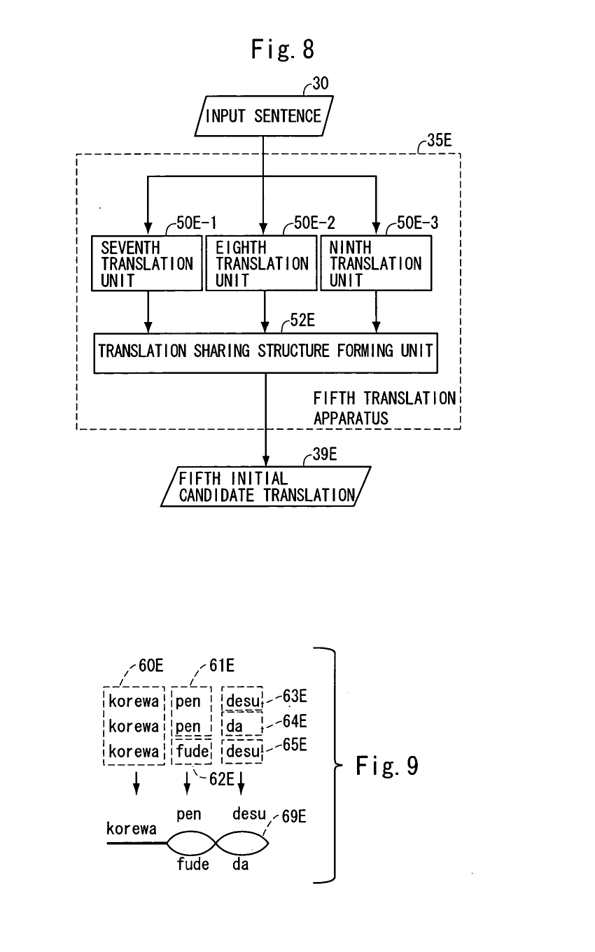

FIG. 8 is a detailed block diagram of the fifth translation apparatus 35E. The fifth translation apparatus 35E includes seventh to ninth translation units 50E-1 to 50E-3 for translating the input sentence to the second language, and a translation sharing structure forming unit 52E for generating a translation having a structure shared by the translations output from the seventh to ninth translation units 50E-1 to 50E-3, as a fifth initial candidate translation 39E.

The process for generating the translation having a shared structure is as follows. Referring to FIG. 9, similar to FIG. 7, an example having the input sentence “This is a pen.” will be described. As shown in FIG. 9, it is assumed that translations “korewa pen desu,” “korewa pen da,” and “korewa fude desu” are obtained as translations of the input sentence.

In generating the shared structure of a translation, basically, the words of a translation is represented by a graph. By way of example, a portion shared by each other (“korewa”) surrounded by frame 60E is represented by one arc in the graph. As to corresponding portions where different word or words are generated, surrounded by frames 61E and 62E and 63E to 65E, respectively, the differences are represented by separate arcs (“pen” and “fude”, “desu” and “da”). The fifth candidate translation 39E is a candidate translation having such a graph structure 69E.

In the present embodiment, the above-described five translation apparatuses are used. It is noted, however, that any other translation system that can translate from the first language to the second language may be used in place of or in addition to the first to fifth translation apparatuses 35A to 35E. Further, any combination of available translation systems including the first to fifth translation apparatuses 35A to 35E may be used as a component of candidate translation generating unit 32.

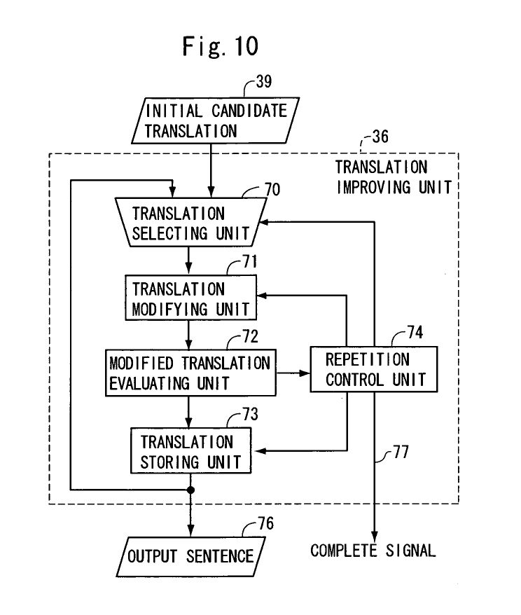

FIG. 10 is a detailed block diagram of translation improving unit 36 shown in FIG. 1. Referring to FIG. 10, translation improving unit 36 includes: a translation selecting unit 70 selecting either one of the initial candidate translation 39 output from candidate translation generating unit 32 and a translation read from a translation storing unit 73 that will be described later; a translation modifying unit 71 for modifying the translation selected by translation selecting unit 70 in accordance with a method that will be described later; and a modified translation evaluating unit 72 evaluating quality of the translation modified by translation modifying unit 71 in accordance with a prescribed evaluation criteria and outputting a resulting score.

Translation improving unit 36 further includes the translation storing unit 73 storing the modified translation together with the score output from modified translation evaluating unit 72, and a repetition control unit 74 determining whether a termination condition for terminating improvement of the translation has been satisfied or not and controlling repetition, in accordance with the result of determination.

Repetition control unit 74 has a function of transmitting a selection control signal to translation selecting unit 70 to select either one of translation storing unit 73 and initial candidate translation 39. It is noted that at the start of processing, translation selecting unit always selects translations 39A to 39E. Whether the translations 39A to 39E are selected or the output of translation storing unit 73 is selected in the following process depends on what scheme is used for modifying the translation.

Repetition control unit 74 further has a function of controlling translation storing unit 73 such that, when it is determined that the termination condition is not satisfied by the score of modified translation evaluating unit 72, one of the translations stored in translation storing unit 73 is selected in accordance with a prescribed method and applied to translation selecting unit 70, a function of controlling modification of the translation by translation modifying unit 71 simultaneously therewith, and a function of transmitting a complete signal 77 indicating that the translation improving process by translation improving unit 36 is completed, to a termination determining unit 38, which will be described later, when it is determined that the termination condition has been satisfied.

The order of selecting the translation from translation storing unit 73 by repetition control unit 74 is determined in connection with the method of modifying translation performed by translation modifying unit 71. For the translation modification performed by translation modifying unit 71, an arbitrary text modification algorithm may be used. In the present embodiment, a method is used in which the translation is modified to have higher likelihood, using a language model and a translation model that are employed in statistical translation.

Various other text modification algorithms may be used. Examples are as follows.

(1) Modification with language model only.

(2) Modification with translation model only.

(3) Modification based on a sentence paraphrasing pattern manually prepared beforehand.

(4) Modification based on a paraphrasing pattern learned mechanically. The learning here may include comparison between a result of machine translation and a correct translation in an example-based corpus, and learning the difference as a transformation pattern.

(5) Word swapping, insertion, deletion and the like are performed at random or in accordance with some model.

Similarly, various methods of evaluating translation quality may be used as the method performed by modified translation evaluating unit 72, including those that would be available in the future. In the present embodiment, likelihood of a translation is computed using a language model and a translation model that are used in statistical translation, and it is determined that the termination condition has been satisfied when likelihood of modified translation no longer improves.

Examples of other possible measures for the translation quality evaluation are as follows.

(1) Likelihood obtained based only on the language model.

(2) Likelihood obtained based only on the translation model.

(3) A measure referred to as “literal translation degree.” As the literal translation degree, Tanimoto factor defined by the following equation may be used.

$$Tanimoto factor = \frac{\vert set of content words in original sentence ⋂ set of content words in translation \vert}{\vert set of content words in original sentence ⋃ set of content words in translation \vert}$$

Here, |●| represents the number of elements in the set, and the content words represents words that are important to determine the content and meaning of the sentence. A method may be available in which whether a word is a content word or not is determined dependent on whether the word exists in a word lexicon.

(4) Multiple reverse-translation similarity. Multiple reverse-translation similarity is a measure representing how similar a result of reverse-translation is to an input sentence, when a translation is reverse-translated to the original first language by a plurality of translation systems. If the similarity is high, the translation is considered to be close to a correct translation of the input sentence.

(5) A method in which a reference translation is generated, and a translation is evaluated using the reference translation. This method includes well-known approaches such as BLEU score, WER (Word Error Rate), NIST score and PER (Position Independent WER). Representative ones are as follows.

<WER> Word-error-rate, which penalizes the edit distance (insertion/deletion/substitution) against reference translations.

<PER> Position independent WER, which penalizes only by insertion/deletion without considering positional disfluencies.

<BLEU> BLEU score, which computes the ratio of the N-gram for the translation results found in reference translations. Contrary to the above error rates WER and PER, the higher scores indicate better translations.

Evaluation may be performed using any other method. Further, a specific evaluation method may be adopted for a specific field. If an effective evaluation method becomes available in the future, such a method may naturally be used.

Repetition control unit 74 stops repetition when the quality of modified translation no longer improves. It is possible, however, to continue modification even when translation quality no longer improves. If the quality degrades, however, repetition is stopped, as hill-climbing method is employed for repetition control in the present embodiment.

In this manner, translation improving unit 36 modifies the translation, determines a translation having the highest evaluation, and outputs the same as an output sentence 76, together with its score, to termination determining unit 38.

Termination determining unit 38 determines whether the process is to be terminated or not, based on output sentence 76 and its score from translation improving unit 36. In the present embodiment, whether the process by translation improving unit 36 has been complete or not is determined on every output from the first to fifth translation apparatuses 35A to 35E included in candidate translation generating unit 32. When the process is complete on every output, a translation that attained the highest score by that time is output as output sentence 42. If the process is not yet complete, the control signal is output to candidate translation generating unit 32 to execute the above-described process on the translation of the next translation apparatus, and the process is continued.

The condition for terminating the process is not limited to the above, and arbitrary condition may be adopted, among the following exemplary conditions. It is noted, however, that the termination condition is related to the method of repetition for improving translation quality, and therefore, there may be a case where a specific method of termination is required by a specific method of repetition, or where a specific method of termination cannot be adopted for a specific method of repetition. These limitations are mere design matters, and a person skilled in the art may appropriately select a satisfactory termination condition.

(1) The process is terminated when a predetermined number of repetition or computation time is exceeded.

(2) The process is terminated when translation quality no longer improves within a predetermined number of repetition or computation time.

(3) The process is terminated when translation quality no longer improves.

(4) The process is terminated when a predetermined target score is attained.

### Operation

Machine translation system 20 operates in the following manner. A number of translation pairs consisting of sentences of the first language and translations of the second language are prepared in bilingual corpus 34 shown in FIG. 3. It is assumed that a language model and a translation model have also been prepared in advance, by some means or another.

Referring to FIG. 1, an input sentence 30 is given to candidate translation generating unit 32.

Referring to FIG. 2, distributing unit 33 applies input sentence 30 to the first translation apparatus 35A.

Referring to FIG. 3, a tf/idf computing unit 50A of the first translation apparatus 35A computes a tf/idf criteria P_{tf/idf} between input sentence 30 and each of the sentences of the first language among all the translation pairs in bilingual corpus 34. Similarly, edit distance computing unit 52A computes edit distance dis(Jₖ, J₀) between input sentence 30 and each sentence Jₖ of the first language among all the translation pairs in bilingual corpus 34.

Score computing unit 54A computes the score described above in accordance with the following equation, using the tf/idf criteria P_{tf/idf} computed by tf/idf computing unit 50A and edit distance dis(Jₖ, J₀) computed by edit distance computing unit 52A.

$$score = \{ \begin{matrix}( 1.0 - α ) ( 1.0 - \frac{dis ( {J}_{k} , {J}_{0} )}{\vert {J}_{0} \vert} ) + α {P}_{tf / idf} ( {J}_{k} , {J}_{0} ) & ( if dis ( {J}_{k} , {J}_{0} ) > 0 ) \\ 1.0 & ( otherwise )\end{matrix}$$

Translation pair selecting unit 56A selects a translation pair having high score from among the translation pairs contained in bilingual corpus 34, and applies the selected pairs to selecting unit 37 shown in FIG. 2, as translation 39A.

Selecting unit 37 selects translation 39A in accordance with the control signal from termination determining unit 38, and applies the same as translation 39 to translation improving unit 36.

Referring to FIG. 10, translation selecting unit 70 in translation improving unit 36 selects the given initial candidate translation 39 and applies the same to translation modifying unit 71. Translation modifying unit 71 applies prescribed modifications to the translation, and applies a plurality of resulting modified translations to modified translation evaluating unit 72. Modified translation evaluating unit 72 evaluates each of the modified translations in accordance with a prescribed evaluation method as described above, and applies the translations together with their scores to translation storing unit 73. Modified translation evaluating unit 72 also applies the scores to repetition control unit 74.

Repetition control unit 74 determines whether these scores satisfy a prescribed condition or not. In the present embodiment, repetition control unit 74 terminates processing when improvement cannot be recognized among any of the scores. Typically, scores of translations resulting from some modifications are improved in the first processing, and therefore, repetition control unit 74 instructs translation selecting unit 70, translation modifying unit 71 and translation storing unit 73 to repeat the process, and further instructs translation storing unit 73 to output one of the translations of which score has been improved among the translations stored last time to translation selecting unit 70.

Following the instruction from repetition control unit 74, translation selecting unit 70 selects one of the modified translations applied from translation storing unit 73, and applies the selected one to translation modifying unit 71. Translation modifying unit 71 applies a number of modifications similar to those described above, on the applied translation. Modified translation evaluating unit 72 again evaluates each of the translations resulting from the modifications and computes the scores, and repetition control unit 74 determines whether the scores are improved. Translation modifying unit 71, modified translation evaluating unit 72, translation storing unit 73 and repetition control unit 74 repeatedly execute the process until the scores of the translations no longer improve.

As described above, one candidate translation is subjected to a number of modifications, scores of the results are evaluated, and a translation of which score has been improved is further subjected to similar modifications and evaluation, and such a process is repeated until score improvement is no longer attained, on every modified translation. Thus, it becomes highly possible to attain a translation of which score has been much improved from the initial candidate translation 39.

When score improvement is no longer attained for any of the translations, repetition control unit 74 controls translation storing unit 73 such that a translation that has attained the highest score through the repeated processes described above is output as an output sentence 76, and in addition, applies a complete signal to termination determining unit 38 shown in FIG. 1.

In response to the complete signal, termination determining unit 38 determines whether the process is to be terminated or not. In the present embodiment, the entire process is terminated only when the process for improving all the translations generated by the first to fifth translation apparatuses 35A to 35E shown in FIG. 2 is completed. Therefore, termination determining unit 38 applies control signal 41 to candidate translation generating unit 32 to repeat the translation improving process described above, on the translations generated by the second translation apparatus 35B.

Referring to FIG. 2, in response to this signal, distributing unit 33 applies input sentence 30 to the second translation apparatus 35B. The second translation apparatus 35B performs the translation process using the first intermediate translation apparatus 50B and the second intermediate translation apparatus 52B to generate translation 39B, which is applied to selecting unit 37.

In accordance with the control signal from termination determining unit 38, selecting unit 37 selects translation 39B output from the second translation apparatus 35B, and applies the same as initial candidate translation 39 to translation improving unit 36. Thereafter, translation improving unit 36 and selecting unit 37 repeat the process similar to the process on the translation from the first translation apparatus 35A.

When the above-described translation improving process is complete on all the translations 39A to 39E generated by the first to fifth translation apparatuses 35A to 35E, repetition control unit 74 shown in FIG. 10 applies a complete signal 77 to termination determining unit 38 shown in FIG. 1. Receiving the complete signal 77, termination determining unit 38 determines that the condition for terminating the process has been satisfied, and outputs a translation having the highest score among the translations obtained by the process by that time as an output sentence 42.

Any translation apparatus may be used for candidate translation generating unit 32, including existing apparatuses and apparatuses that will be available in the future.

According to the present embodiment, translations of one input sentence are obtained through a plurality of mutually different machine translation systems, the translations are improved using each of the thus obtained translations as a starting point, translations having best scores are selected, and among these translations, one having the highest score is selected as a final translation. As a plurality of translations are used as starting points, it is highly possible that not only a local solution but a global optimal solution is obtained. Further, any machine translation system may be used for obtaining the initial translation, and therefore, existing machine translation systems can effectively used. Further, it is possible to utilize any machine translation system or any method of evaluating translation quality that would be developed in the future. Thus, using the present framework, further improvement of translation quality is expected.

Provided that the criteria and method of evaluating translation quality and a plurality of basic machine translation systems are established, quality of translation between arbitrary languages can be improved, regardless of the combination of languages.

Further, in the machine translation system described above, basically, no human intervention is required to improve translation quality, system framework can be developed relatively easily, and the system can be realized in a short period of time.

In the embodiment described above, among the modified translations, only those having their scores improved are subjected to repeated process of translation improvement. The present invention, however, is not limited to such an embodiment. By way of example, only a prescribed number (for example, one) of translations ranked high among the modified translations of which scores have been improved may be subjected to subsequent modification and evaluation.

Though a plurality of different modifications are preferred, only one modification may suffice.

In the embodiment described above, a plurality of machine translation apparatuses are operated in order, that is, one machine translation apparatus is operated at a time. The present invention is not limited to such an embodiment, and the plurality of machine translation apparatuses may be operated simultaneously and in parallel with each other. Alternatively, as in the second embodiment, the initial machine translation and the following improvement of translations may both be performed in parallel.

### Second Embodiment

As described above, the apparatus of the first embodiment can be implemented with a computer. Further, as is apparent from FIG. 2, for example, the apparatus of the first embodiment includes therein components that can operate independent from each other (such as the first to fifth translation apparatuses 35A to 35E, the first to third translation units 50C-1 to 50C-3, the fourth to sixth translation units 50D-1 to 50D-3, and the seventh to ninth translation apparatuses 50E-1 to 50E-3). Therefore, using a communication function and a task distributing function of the computer, the system in accordance with the first embodiment may be realized by a plurality of network-connected computers. The system in accordance with the second embodiment has a plurality of computers connected to each other through a network, so that processes that can be executed in parallel among the above-described processes are executed in parallel by separate computers.

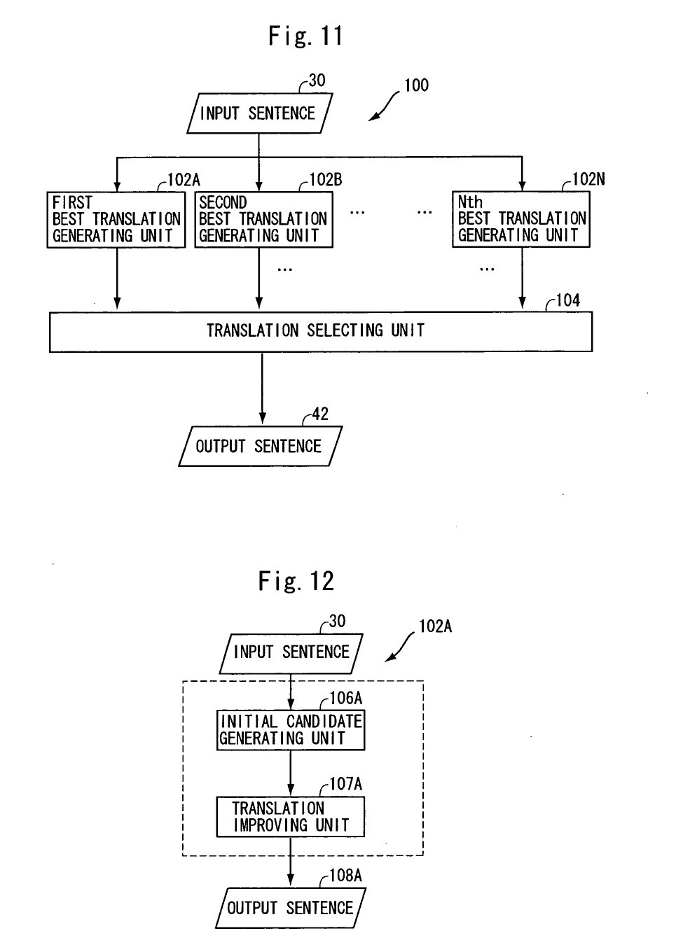

FIG. 11 shows a schematic functional configuration of the machine translation system 100. Referring to FIG. 11, machine translation system 100 includes: a plurality of best translation generating units 102A to 102N performing the above-described translation improving process on translations prepared by separate translation systems for the input sentence 30, for generating best translations; and a translation selecting unit 104 for selecting and outputting as output sentence 42 the translation having the highest score from among the best translations separately generated by the best translation generating units 102A to 102N.

Best translation generating units 102A to 102N can be implemented with separate computers and programs running thereon. A host computer may be provided connected to these computers via a network, and the host computer may distribute the input sentence 30 to these computers, receive translations from respective computers, and select the best translation from among the received translations.

FIG. 12 shows, as an example, a functional configuration of the first best translation generating unit 102A. As described above, best translation generating unit 102A is implemented with a computer connected through a network to the host computer and a program running thereon. Other best translation generating units also have similar configurations, except that different translation units are provided for preparing the initial candidates.

Best translation generating unit 102A includes: an initial candidate generating unit 106A, which is similar to candidate translation generating unit 32 shown in FIG. 2 but has only one translation apparatus; and a translation improving unit 107A performing a process similar to that of translation improving unit 36 shown in FIG. 10 on the translation generated by initial candidate generating unit 106A as an initial candidate translation to generate an output sentence 108A of best translation generating unit 102A and transmitting the same to the host computer.

The functional configuration of translation improving unit 107A is similar to that of translation improving unit 36 shown in FIG. 10. It is noted, however, that the processes realized by translation modifying unit 71 and modified translation evaluating unit 72 shown in FIG. 10 can be adapted to be performed in parallel. Therefore, these processes are performed simultaneously and in parallel with each other by network-connected other computers.

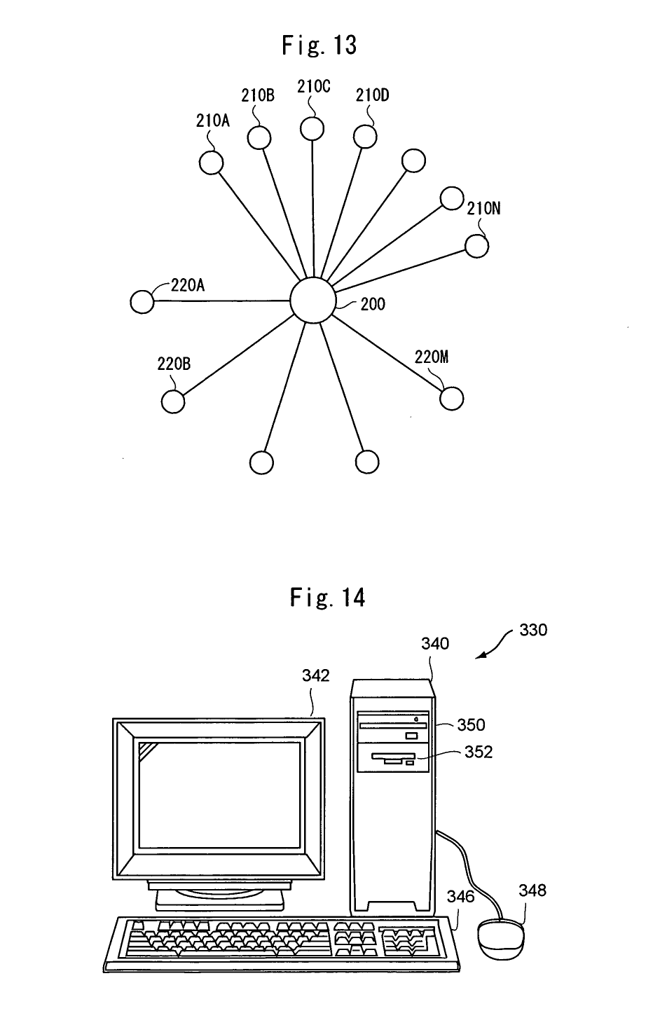

FIG. 13 schematically shows a network configuration of the machine translation system utilizing the computer network described above. Referring to FIG. 13, the machine translation system includes: a host computer 200 performing overall control of the system operation, and performing the process of distributing the input sentence and the process of selecting the translation having the highest score from among the translations; initial candidate generating computers 210A to 210N receiving the input sentence from host computer 200, performing machine translation simultaneously and in parallel with each other and returning the results as initial candidate translations to host computer 200; and translation improving computers 220A to 220M receiving the translations generated by separate initial candidate generating computers from host computer 200 and performing the translation improving process using the received translations as initial candidates.

By the machine translation system having such a configuration, a huge amount of computation can be executed simultaneously and in parallel. Therefore, the time until the final output sentence is obtained can significantly be reduced. Further, the quality and application range of the resulting output sentence is comparable to that of the first embodiment. Further, by dividing the translation improving process into smaller steps, it becomes possible to execute the process simultaneously and in parallel in hierarchical manner using a larger number of computers, and thus, the speed of processing can further be increased.

### Expansion of Embodiments

The following functions may further be added to the configurations of the first and second embodiments.

(1) The pairs of input sentence 30 and output sentence 42 obtained by the machine translation system of the above-described embodiments are stored, so as to return the same output sentence 42 to the same input sentence 30. This eliminates the necessity of repetitive processing, and therefore, the speed of processing can remarkably improved the next time.

(2) Pairs of input sentence 30 and output sentence 42 obtained by the machine translation system of the above-described embodiments are collected to expand the bilingual corpus. Using the expanded bilingual corpus, the example-based translation or statistical translation is re-organized. By such an expansion, it becomes highly possible to improve coverage and quality of example-based translation or statistical translation.

### Computer Implementation

The machine translation system in accordance with the present embodiment may be implemented with a computer hardware, a program executed on the computer hardware, and the bilingual corpus, translation model and language model stored in a storage of the computer.

Such a program may be readily realized by a person skilled in the art from the description of the embodiments above.

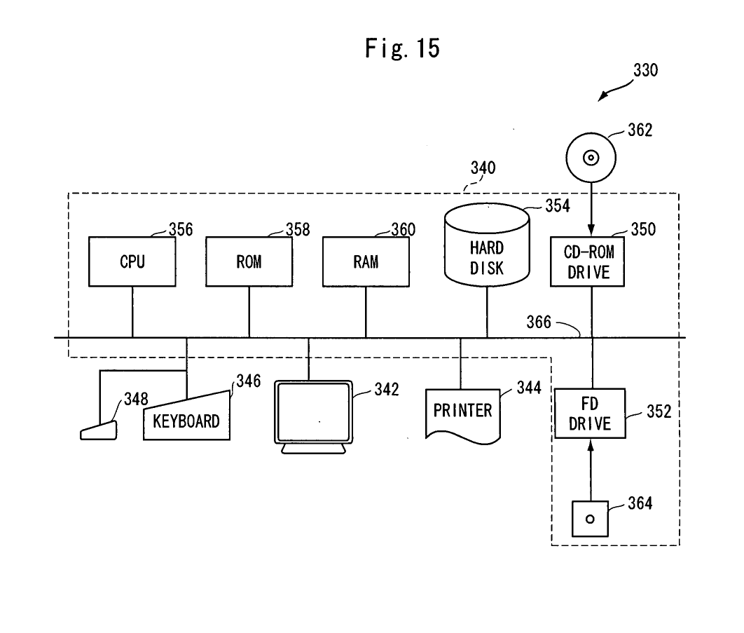

FIG. 14 shows an appearance of a computer system 330 implementing the machine translation system, and FIG. 15 shows an internal configuration of computer system 330.

Referring to FIG. 14, computer system 330 includes a computer 340 having a FD (Flexible Disk) drive 352 and a CD-ROM (Compact Disc Read Only Memory) drive 350, a key board 346, a mouse 348 and a monitor 342.

Referring to FIG. 15, computer 340 includes, in addition to FD drive 352 and CD-ROM drive 350, a CPU (Central Processing Unit) 356, a bus 366 connected to FD drive 352 and CD-ROM drive 350, a read only memory (ROM) 358 storing a boot-up program and the like, and a random access memory (RAM) 360 connected to bus 366 and storing program instructions, system program, work data and the like. Computer system 330 further includes a printer 344.

Though not shown, computer 340 may further include a network adapter board providing a connection to a local area network (LAN).

A computer program to cause computer system 330 to operate as a machine translation system described above is stored on a CD-ROM 362 or an FD 364 that is mounted to CD-ROM drive 350 or FD drive 352, and transferred to a hard disk 354. Alternatively, the program may be transmitted through a network, not shown, and stored in hard disk 354. The program is loaded to RAM 360 at the time of execution. The program may be directly loaded to RAM 360 from CD-ROM 362, FD 364 or through the network.

The program includes a plurality of instructions that cause computer 340 to execute operations as the machine translation apparatus in accordance with the present embodiment. Because some of the basic functions needed to perform the present method will be provided by the operating system (OS) running on computer 340 or a third party program, or modules of various tool kits installed on computer 340, the program does not necessarily contain all of the basic functions needed to the system and method of the present embodiment. The program may need to contain only those parts of instructions that will realize the machine translation apparatus by calling appropriate functions or “tools” in a controlled manner such that the desired result will be obtained. How the computer system 330 operates is well known, and therefore, it is not described here.

The embodiments as have been described here are mere examples and should not be interpreted as restrictive. The scope of the present invention is determined by each of the claims with appropriate consideration of the written description of the embodiments and embraces modifications within the meaning of, and equivalent to, the languages in the claims.

1. A machine translation system, comprising:
distributing means for distributing an input sentence to a plurality of machine translation apparatuses each generating a translation of a second language for said input sentence of a first language, and receiving, from each of said plurality of machine translation apparatuses, the translation of said second language for said input sentence;
translation improving means, using each of the translations of said second language received by said distributing means as a starting point, for improving the translation such that an evaluation in accordance with a prescribed evaluation method is improved; and
translation selecting means for selecting, as a translation of said input sentence, a translation satisfying a prescribed condition, among the translations improved by said translation improving means.

2. The machine translation system according to claim 1, further comprising
said plurality of machine translation apparatuses connected to said distributing means.

3. The machine translation system according to claim 2, wherein said plurality of machine translation apparatuses include first and second machine translation apparatuses of mutually different types.

4. The machine translation system according to claim 1, wherein said translation improving means includes
translation modifying means for applying a prescribed modification on an input translation,
translation evaluating means for evaluating the translation modified by said translation modifying means, and
repetition control means for determining whether the evaluation by said translation evaluating means has been improved from the evaluation of the input translation, and for controlling said translation modifying means and said evaluating means such that modification and evaluation are repeated until the evaluation is no longer improved.

5. The machine translation system according to claim 4, wherein
said translation modifying means includes means for applying a plurality of different modulations on one translation to generate a plurality of modified translations; and
said evaluating module includes means for evaluating each of the plurality of modified translations.

6. The machine translation system according to claim 5, wherein
said repetition control means includes means for controlling said translation modifying means and said evaluating means such that modification and evaluation are repeated until the evaluation by said evaluating means is no longer improved, for each of the plurality of translations modified by said translation modifying means.

7. The machine translation system according to claim 5, wherein
said repetition control means includes means for controlling said translation modifying means and said evaluating means such that modification and evaluation are repeated until the evaluation by said evaluating means is no longer improved, for each of a prescribed number of translations ranked high among the plurality of translations modified by said translation modifying means.

8. The machine translation system according to claim 4, wherein
said translation evaluating means includes means for computing likelihood of a translation based on a language model of said second language and a translation model from said second language to said first language.

9. The machine translation system according to claim 1, wherein
said translation improving means includes translation modifying means for applying a prescribed modification on an input translation,
translation evaluating means for evaluating the translation modified by said translation modifying means, and
repetition control means for controlling said translation modifying means and said evaluating means such that modification and evaluation are repeated by a predetermined number of times.

10. The machine translation system according to claim 9, wherein
said translation selecting means includes means for selecting a translation having highest evaluation by said evaluating means from among the plurality of translations obtained through repetition controlled by said repetition control means.

11. The machine translation system according to claim 9, wherein
said translation evaluating means includes means for computing likelihood of a translation based on language model of said second language and a translation model from said second language to said first language.

12. A computer readable recording medium, recording a computer program that causes, when executed by a computer, said computer to operate as the machine translation system according to claim 1.

13. A control apparatus of a machine translation system, comprising:
translation obtaining means for providing an input sentence of a first language to a plurality of machine translation apparatuses of mutually different types and obtaining corresponding translations of a second language;
modified translation obtaining means for applying the translations of said second language obtained by said translation obtaining means to a plurality of translation modifying means for modifying the translation to have an evaluation in accordance with a prescribed evaluation method, using each of the translations of said second language as a starting point, and receiving modified translations and respective accompanying evaluation values; and
translation selecting means for selecting and outputting as a translation of said input sentence, one of the translations received by said modified translation obtaining means, which satisfies a prescribed condition.

14. The control apparatus of a machine translation system according to claim 13, wherein
said translation selecting means includes means for selecting one having the highest score among the translations received by said modified translation receiving means.

15. A method of machine translation, comprising the steps of:
preparing a plurality of candidate translations by distributing an input sentence to each of a plurality of machine translation apparatuses for generating a translation of a second language for said input sentence of a first language, and receiving translations of said second language for said input sentence;
modifying each of said plurality of candidate translations received in said step of preparation and improving each candidate translation so that an evaluation computed in accordance with a prescribed evaluation method is improved; and
selecting, from among the improved candidate translations improved in said step of improving, one that satisfies a prescribed selection condition, as a translation of said input sentence.

16. The method of machine translation according to claim 15, wherein
said step of improving includes the steps of
modifying each of said plurality of candidate translations in accordance with a prescribed modification method;
evaluating the candidate translations modified in said step of modifying, in accordance with said evaluation method;
determining whether the evaluation value of the candidate translation given in said step of evaluation has been improved from the evaluation of the candidate translation input in said step of modifying; and
repeating, on each of the modified translations modified in said step of modifying, said steps of modification and evaluation, until the evaluation value no longer improves in said step of determination.

17. The method of machine translation according to claim 16, wherein
said step of evaluation includes the step of computing, as said evaluation value, likelihood of the modified translation modified in said step of modification, using a language model of said second language and a translation model from said second language to said first language.

18. The method of machine translation according to claim 16, wherein
said step of modification includes the step of generating a plurality of modified candidate translations by applying a plurality of modifications on one candidate translation; and
said step of evaluation includes the step of evaluating each of said plurality of modified candidate translations.

19. The method of machine translation according to claim 18, wherein
said step of repeating includes the step of repeating said steps of modification and evaluation until the evaluation in said step of evaluation is no longer improved, for each of the plurality of candidate translations modified in said modifying step.

20. The method of machine translation according to claim 18, wherein
said step of repeating includes the step of repeating said steps of modification and evaluation until the evaluation in said step of evaluation is no longer improved, for each of a prescribed number of translations ranked high among the plurality of candidate translations modified in said modifying step.

21. The method of machine translation according to claim 16, wherein
said step of selecting includes the step of selecting a translation attaining highest evaluation in said step of evaluation from among the plurality of translations obtained through repetition in said step of repetition.

22. The method of machine translation according to claim 15, wherein
said step of improving includes the steps of
applying a prescribed modification on an input candidate translation,
evaluating each of the candidate translations modified in said step of modification in accordance with said evaluation method, and
repeating said steps of modification and evaluation by a predetermined number of times.

23. The method of machine translation according to claim 22, wherein
said step of selecting includes the step of selecting a translation attaining highest evaluation in said step of evaluation, from among the plurality of candidate translations obtained through the repetition in said step of repetition.

24. The method of machine translation according to claim 15, wherein
said step of evaluation includes the step of computing, as said evaluation value, likelihood of the candidate translation modified in said step of modification, based on a language model of said second language and a translation model from said second language to said first language.
